(19) United States
(12) Patent Application Publication
(10) Pub. No.: US 2002/0020243 A1
(43) Pub. Date: Feb. 21, 2002

(54) Rotary shaft vibration damping

(76) Inventor: John C. Ziegert, Gainesville, FL (US)

Correspondence Address: Miles & Stockbridge PC, Suite 500, 1751 Pinnacle Drive, McLean, VA, 22102, US

(21) Appl. No.: 09/859,805

(22) Filed: May 18, 2001

Related U.S. Application Data
(60) Provisional application No. 60/205,547, filed on May 22, 2000.

(51) Int. Cl. G05G 11/00

(52) U.S. Cl. 74/490; 74/813 R

(57) ABSTRACT

Vibrations of rotary shafts, such as shafts of cutting tools used in high speed machining, are reduced by damping structures in holes in the shafts. The damping structures comprise fingers that are urged outwardly by centrifugal force due to rotation of the shafts and that slide relative to adjacent shaft surfaces due to shaft vibrations, so that vibrational energy is absorbed frictionally. Chatter, a self-excited vibration of a cutting tool, can be substantially reduced in this manner.

### CROSS REFERENCE TO CO-PENDING APPLICATION

This application claims the benefit of provisional Application No. 60/205,547 filed May 22, 2000, incorporated herein by reference.

### BACKGROUND OF THE INVENTION

This invention is concerned with damping vibrations of rotary shafts. The invention has particular utility in damping vibrations known as chatter, generated when a rotary cutting tool is applied to a workpiece, but is useful more generally in the damping of vibrations of rotary shafts in other environments, such as the shafts of turbines, for example.

Chatter, a self-excited vibration of a cutter, such as a milling tool applied to a workpiece, is a well known phenomenon. Milling is characterized by a pattern of intermittent cutting forces as each tooth of a cutter enters and leaves a workpiece. The periodic nature of the cutting force gives rise to vibrations of the tool relative to the workpiece. Each tooth of the tool leaves a cut surface behind it. The exact location of each point on that surface relative to the nominal tooth position is dependent on the magnitude and phase of the tool in its vibration as it passes through the workpiece.

In general, the tool's vibration will cause the surface left by the tool to have some “waviness”. If the following tooth is not in the same phase of its vibration as the previous tooth at the time it enters the workpiece, then the chip thickness it encounters will change as it passes through the cut and the wavy surface left by the previous tooth. This leads to a variation in the magnitude and direction of the cutting force, which changes the amplitude of vibration slightly. For some cutting conditions, this changing pattern of cutting force, and therefore chip thickness, magnifies in each cycle, leading to excessive vibration known as chatter. Chatter leads to poor surface finish and shortened tool life, and may even lead to damage of the machine employing the cutting tool.

Avoidance of chatter is of particular concern in High Speed Machining (HSM), a process which is revolutionizing the manufacture of a number of products in the discrete part industry. Perhaps the easiest, and most common method for chatter avoidance is proper selection of spindle speed in HSM, to ensure desired phasing and stable cuts. This technique is known as “spindle speed regulation”. However, for most end milling operations, these stable spindle speeds occur at very high rpm. For example, if the most flexible natural frequency of an end mill is 1000 Hz, and the cutting tool has four cutting edges, then the most desirable spindle speed for chatter-free machining will be in the neighborhood of 15,000 rpm, depending on the amount of damping in the system. This speed is attainable with current generation spindles and will provide satisfactory results, provided the tool material gives adequate life at this speed. In general, for aluminum and other easy to machine materials, adequate tool life can be obtained at even much higher speeds.

Methods other than spindle speed regulation can be used to increase stable cut depth, to maximize Material Removal Rate (MMR), and thus to maximize productivity in milling operations. One such method relies on changing the dynamic stiffness of the tool. Dynamic stiffness is defined as the product of stiffness and damping ratio. Increased dynamic stiffness, whether achieved through increased stiffness or increased damping, will allow for much deeper stable cuts at all spindle speeds.

In general, if the dynamic stiffness of the most flexible mode of vibration of a tool can be increased by some multiple, the chatter-free depth of cut at any speed, and the resulting MMR, will increase by the same multiple. The stiffness is generally determined by the overall geometry (length, diameter, etc.) of a cutter body and by its material properties. To maximize stiffness of a cutting tool, machinists and tooling engineers tend to make use of the largest diameter and shortest tools which can create the necessary part features. However, for many machining operations, the need to produce deep pockets with small radii in the corners of a workpiece dictates the use of long, slender, and relatively flexible tools. It may not be possible to rely upon tool stiffness for chatter avoidance in these circumstances, but increasing damping will have the same effect as increasing the stiffness. In long, slender, and relatively flexible tools damping is typically very low, usually 1% or less.

### BRIEF DESCRIPTION OF THE INVENTION

The present invention achieves significantly increased damping of vibrations of rotary shafts, such as the shafts of milling cutters, by utilizing centrifugal force to create large frictional forces at an interface between sliding damping elements and adjacent surfaces.

In one embodiment, an elongated damping structure is press fit into a hollow cylindrical rotary shaft. The damping structure comprises a cylindrical rod having a plurality of fingers formed by partially splitting the rod longitudinally from one end, so that the fingers are joined to each other at the opposite end of the rod. The free ends of the fingers enter the hollow shaft first. The damping structure rotates with the hollow shaft, and centrifugal force urges the fingers outwardly to increase the pressure between the fingers and inner surface portions of the hollow shaft. Bending vibrations of the hollow shaft cause longitudinal sliding movement of the fingers relative to adjacent inner surface portions of the shaft, dissipating energy frictionally and resulting in substantial damping of shaft vibrations.

### BRIEF DESCRIPTION OF THE DRAWINGS

The invention will be further described in conjunction with the accompanying drawings, which illustrate preferred and exemplary (best mode) embodiments, and wherein:

FIG. 1 is a perspective view showing a hollow cylinder, vibrations of which are to be damped, along with a damper to be inserted in the cylinder;

FIG. 2 is an end view showing the damper inserted in the cylinder;

FIG. 3 is a perspective view of a milling machine;

FIG. 4 is a perspective view of another embodiment of a damper in accordance with the invention;

FIG. 5 is an end view of a hollow shaft with an inner surface configuration different from that shown in FIG. 1;

FIG. 6 is an end view of a damper designed for use with the shaft shown in FIG. 5;

FIG. 7 is a fragmentary sectional view showing a relationship of a finger of the damper of FIG. 6 and an internal recess in the shaft of FIG. 5;

FIG. 8 is a diagrammatic view to explain the operation of the embodiment shown in FIGS. 5-7;

FIG. 9 is a perspective view of another embodiment, in which a pair of dampers are inserted in a hollow shaft;

FIG. 10 is a longitudinal cross-section of the same embodiment, with the dampers inserted in the shaft;

FIG. 11 is a longitudinal sectional view showing a modification of the embodiment of FIGS. 9 and 10;

FIG. 12 is a perspective view of another embodiment, employing concentric dampers; and

FIGS. 13 and 14 are end views of further embodiments.

### DETAILED DESCRIPTION OF THE INVENTION

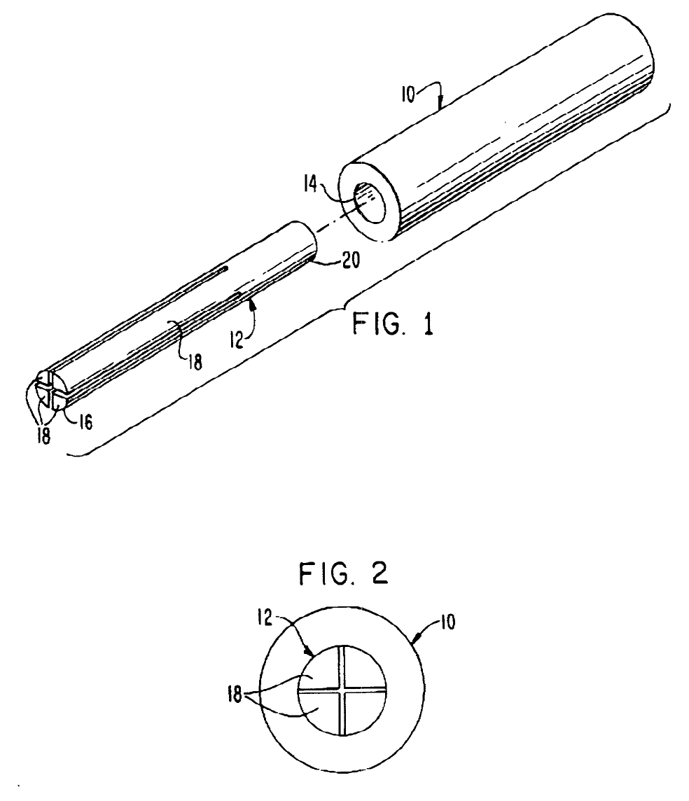

FIGS. 1 and 2 show an embodiment of the invention described earlier, in which it is desired to damp vibrations of a rotary shaft, such as a cylindrical shaft 10 of a cutting tool. Cutting flutes (not shown) can be ground into the outer surface of the shaft. A damper, or damping structure 12 comprises a cylindrical rod that is press fit into a cylindrical center hole 14 provided in the shaft. The rod is slit longitudinally along most of its length from one end 16 to provide a plurality of fingers 18 that are joined at the opposite end 20 of the rod. In the form shown in FIGS. 1 and 2, four fingers are provided by slitting along orthogonal axial planes, so that each finger has an arcuate outer surface that engages an opposing arcuate inner surface portion of the hollow shaft.

The damping structure is anchored to the hollow shaft at the end 20 and rotates with the shaft. Centrifugal force causes the outer surface of the fingers 18 of the damping structure to press against adjacent inner surface portions of the hollow shaft with a force that can be a very large multiple of the weight of the fingers, creating large interface pressures. The neutral bending surfaces of the fingers are displaced outwardly from the neutral bending surface of the hollow shaft (which contains the axis of shaft rotation), and when the shaft bends, the axial strain experienced on the outer surfaces of the fingers is different from the axial strain experienced on the inner surface portions of the shaft, causing relative longitudinal sliding between the opposing surfaces. This relative sliding dissipates energy frictionally. The amount of energy dissipated depends on the frictional force between the opposing surfaces, which is dependent on the normal force between them and the amount of sliding. In the absence of rotation, there will be little, if any, normal force, and therefore little energy dissipation. However, during rotation, particularly at high speeds, the aforementioned large interface pressures result in very large frictional forces and substantial damping.

Providing a central hole in a rotary shaft, will, of course, decrease stiffness of the shaft. However, the area moment of inertia for circular cross-sections, and thus the bending stiffness, is proportional to the 4^{th} power of the diameter, so that the center portion of a cylindrical shaft contributes little to the overall stiffness, and the stiffness loss is minimal for holes of reasonable size. For example, if the diameter of the central hole is one-half the outer diameter of the shaft, the bending stiffness drops by only 7%. This stiffness loss can be easily compensated by the damping achieved in accordance with the invention, providing an overall increase in dynamic stiffness.

The damping achieved by the invention may be termed “centrifugal damping”, because it uses centrifugal force to achieve the desired frictional damping. If one computes the centripetal acceleration experienced by a point on the surface of a tool rotating at typical HSM speeds, the result is quite surprising. For example, consider a 25 mm diameter tool rotating at 40,000 rpm, a typical top speed of commercial HS spindles. The centripetal acceleration experienced by a point on the surface of the tool amounts to over 22,000 g. Therefore, if a point mass were placed on the surface of this tool, it would need a centrifugal force in excess of 22,000 times its own weight to remain in place. Centrifugal damping utilizes such high centrifugal forces to achieve desired damping.

An experiment to verify the centrifugal damping effect used the hollow shaft 10 and the damping structure 12 shown in FIGS. 1 and 2. The shaft 10 consisted of a mild steel cylinder, 125 mm long, with 25 mm outer diameter and 15 mm inner diameter. The damping structure 12 was a mild steel rod machined to have a press fit into the hollow shaft, prior to slitting the shaft from one end for 100 mm of the total Length, thereby forming four fingers 18, with very little bending stiffness, that slid easily into the hollow shaft., The final solid 25 mm of the damping structure insert was then pressed into the shaft, and the assembly was inserted into a shrink-fit tool holder with the solid end of the damping structure inside the holder body. The holder was then mounted into the high-speed spindle on a five-axis machine.

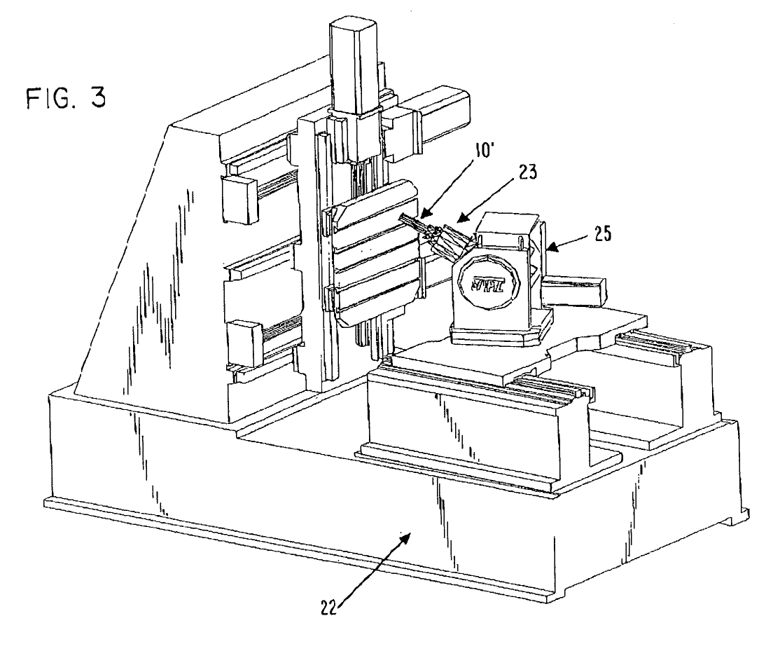

FIG. 3 shows a typical machine 22 with a cutting tool 10′ attached to a spindle 23 of the machine tool head 25. The cutting tool shown has flutes on its outer surface, but in the aforesaid experiment flutes were unnecessary. In practice, various types of cutters or drills, for example, can be provided with a central through-hole or a blind hole as may be appropriate to receive a damping structure insert in accordance with the invention. It should be noted that a hollow shaft of a spindle itself may be provided with a damper in accordance with the invention.

In the aforesaid experiment, transfer functions were measured at various spindle speeds, both with and without the centrifugal damper inserted. The shaft was excited with a hammer and the vibrational displacements were measured with a capacitance probe. In this manner, it is possible to measure the dynamic response of the shaft when it is rotating.

With no damping structure, and the spindle not rotating, the hollow shaft exhibited a primary bending mode with a natural frequency of approximately 1827 Hz and a damping ratio of approximately 0.018. These parameters remained essentially constant during the experiment. When the damping structure was press-fit into the hollow shaft and the spindle was stationary, the primary bending mode had a frequency of 1707 Hz, and a damping ratio of approximately 0.027. The natural frequency of the assembly decreased due to the added mass of the insert. The slightly higher damping ratio is believed to be due to some friction between the fingers and the inner surface of the hollow shaft, since the outer diameter of the damping structure was slightly larger than the inner diameter of the shaft.

When the assembly was rotating at 5000 rpm, the measured damping ratio of this mode appeared to increase to approximately 0.056, an increase of 107%. Thus, the dynamic stiffness was increased by an equal amount, meaning that a stable cut depth would also be increased by this amount if the shaft 10 were used to provide a cutting tool such as an end mill. Further tests have shown that as the spindle speed increased from 5000 rpm to 30,000 rpm, the damping approximately doubled.

The invention is not limited to damping structures with four fingers. The principles of the invention can be applied, for example, to embodiments with more or fewer fingers, to embodiments with multiple damping structure inserts, to embodiments with hollow damping structures, and to embodiments with individual shaft openings that receive individual fingers.

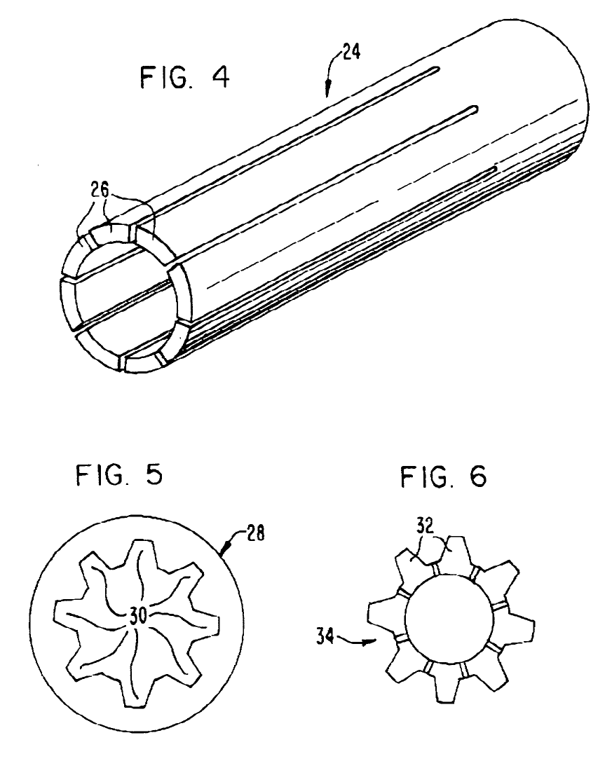

FIG. 4 shows an embodiment with a multi-fingered hollow damping structure 24, in this case with eight fingers 26, constructed as an insert in a hollow shaft, such as the shaft 10 of FIG. 1.

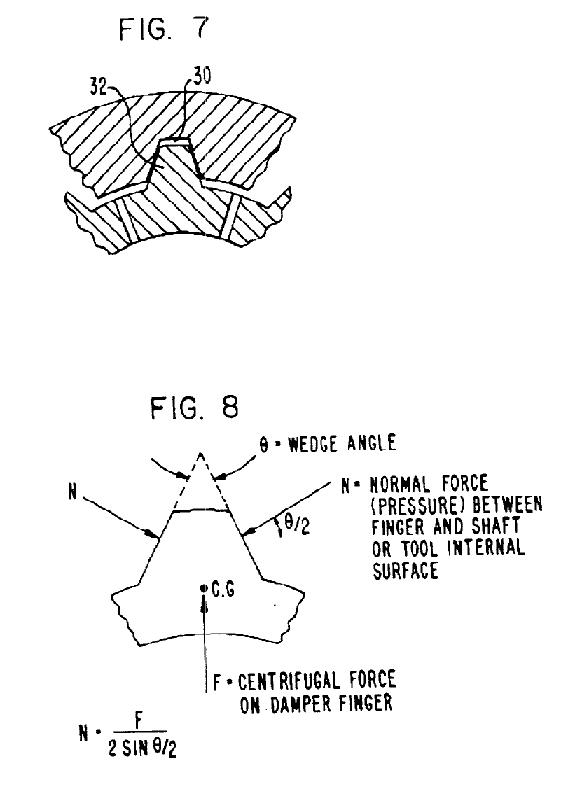

FIG. 5 is an end view of a hollow shaft 28 in an embodiment in which a central hole has a plurality of circumferentially spaced peripheral recesses 30 that are wedge-shaped in cross-section for receiving mating wedge-shaped fingers 32 of a damping structure 34 shown in the end view of FIG. 6. The recesses become narrower radially outward from the rotational axis of the shaft. Wedging action increases the pressure at the interfaces of the fingers and their recesses. FIG. 7 is a close-up view of a single damping finger 32 inserted in a single recess 30. FIG. 8 is a diagram illustrating that the interface pressure increases as the wedge angle decreases.

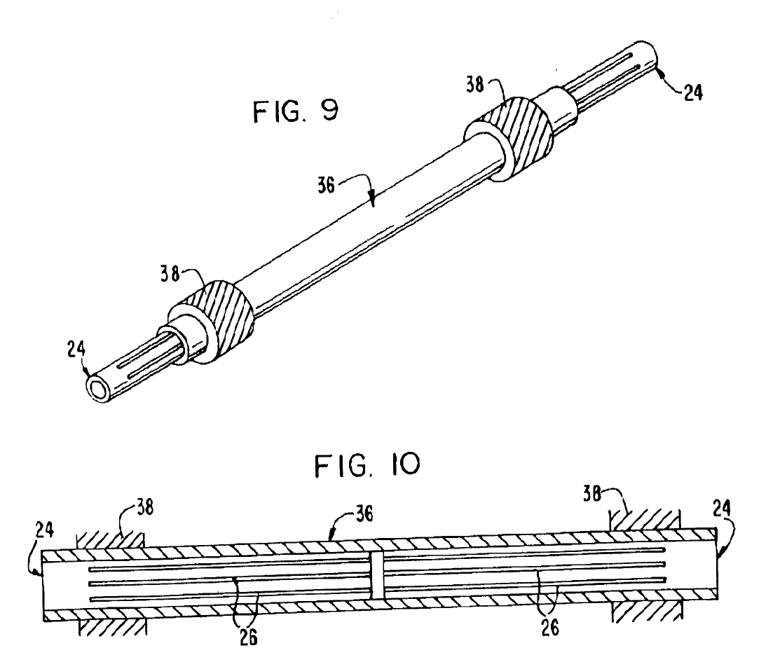

FIGS. 9 and 10 show an embodiment in which two damping structures 24 are inserted into a hollow cylindrical rotary shaft 36 from opposite ends. The shaft, which may be part of a turbine, for example, is supported on bearings 38 adjacent to the respective ends. As shown in FIG. 10, with the damping structures fully inserted, the free ends of the fingers 26 of the respective damping structures face each other. FIG. 11 illustrates a modification in which fingers 27 of respective damping structures 29 are interleaved.

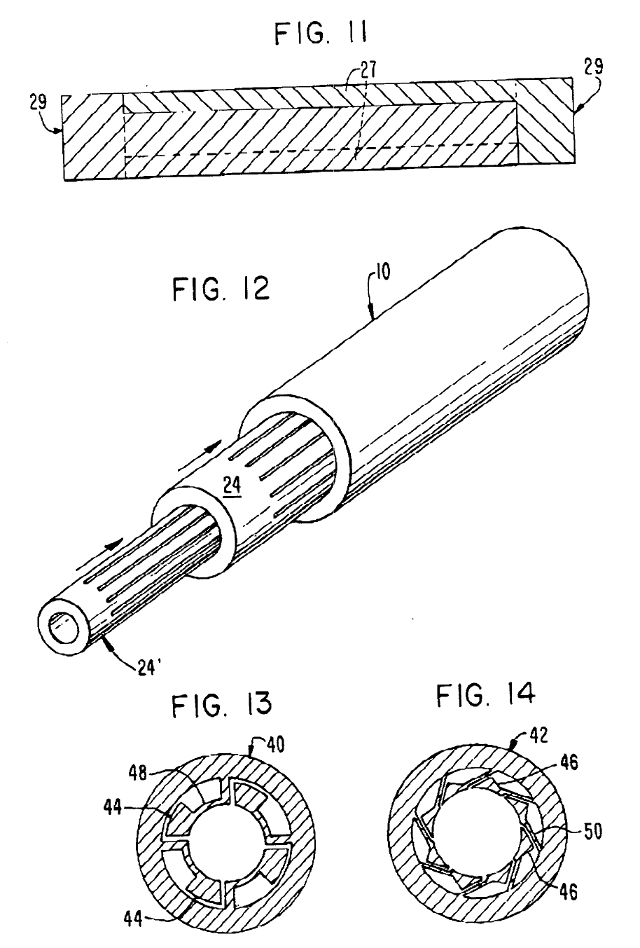

FIG. 12 shows an embodiment employing a pair of concentric damping structures 24, 24′ which are inserted in a hollow, cylindrical rotary shaft 10. The fingers of the inner damping structure 24′ slide on the fingers of the outer damping structure 24 in response to bending vibrations of the shaft. More than two concentric dampers can be employed, and the dampers can be inserted in opposite ends of a shaft, like FIG. 9, and still fit inside each other.

In some circumstances, it may be appropriate to provide a damping structure that is integral with a hollow shaft. FIGS. 13 and 14 show possible internal configurations of shafts 40 and 42, in which fingers 44 and 46 are supported by thin flexures 48 and 50. Wire EDM may be used to cut thin axial slots along the length of a shaft from an initial central hole, to form the fingers and flexures. Centrifugal force will push the fingers outwardly into contact with adjacent internal surface portions of the shaft.

The dampers employed in the invention are preferably formed of a high density material, such as steel or carbide, in particular a material having good friction characteristics, since it is desired to provide a large coefficient of friction at the interface where damping fingers slide on adjacent inner surface portions of a shaft. Interfaces at which relative sliding movement occurs can be treated appropriately to increase the coefficient of friction. For example, a high friction material can be coated, plated, or otherwise applied to the outer surfaces of sliding fingers and/or the adjacent inner surface portions of a shaft.

While preferred embodiments of the invention have been shown and described, it will be apparent to those skilled in the art that modifications can be made without departing from the principles and spirit of the invention, the scope of which is set forth in the accompanying claims.

What is claimed is:

1. A vibration damper for a hollow rotary shaft, comprising an elongated structure adapted to be inserted in the shaft for rotation therewith and having a plurality of fingers that are constructed to be urged against inner surface portions of the shaft in response to rotation of the shaft and to slide relative to the shaft in response to shaft vibrations.

2. A vibration damper according to claim 1, wherein the fingers are joined to each other only at one end thereof.

3. A vibration damper according to claim 2, wherein the structure is a rod that is slit longitudinally from one end thereof to provide the fingers.

4. A vibration damper according to claim 1, wherein the structure is a hollow rod.

5. In combination with a hollow rotary shaft, a vibration damper inserted in the shaft and having a plurality of fingers that extend longitudinally of the shaft, and that are constructed to be urged against inner surface portions of the shaft by centrifugal force in response to rotation of the shaft, and to slide relative to the inner surface portions in response to vibration of the shaft.

6. A combination according to claim 5, wherein the fingers are free from each other at one end of the vibration damper and are joined to each other at an opposite end of the vibration damper.

7. A combination according to claim 6, wherein the vibration damper comprises a rod that is slit longitudinally from one end thereof to provide the fingers.

8. A combination according to claim 7, wherein there are a plurality of such vibration dampers in the shaft.

9. A combination according to claim 7, wherein there are a pair of such vibration dampers in the shaft, and wherein said one end of one vibration damper faces said one end of the other vibration damper.

10. A combination according to claim 9, wherein fingers of one vibration damper are interdigitated with fingers of the other vibration damper.

11. A combination according to claim 5, wherein the vibration damper is hollow and has a further such vibration damper inserted therein, and wherein the fingers of the further vibration damper are constructed to be urged against inner surface portions of the first-mentioned vibration damper in response to centrifugal force when the shaft rotates, and to slide relative to the inner surface portions of the first-mentioned vibration damper in response to vibration of the shaft.

12. A combination according to claim 5, wherein the inner surface portions of the rotary shaft are parts of a plurality of circumferentially spaced wedge-shaped recesses which become narrower radially outward from a rotational axis of the shaft, and wherein the fingers are inserted in respective wedge-shaped recesses and are configured so as to mate with the wedge-shaped recesses.

13. In combination with a rotary shaft, a vibration damper comprising a plurality of fingers extending in corresponding recesses in the shaft, the fingers being constructed to be urged outwardly against surface portions of the recesses in response to centrifugal force when the shaft rotates, and to slide relative to the surface portions of the recesses in response to vibration of the shaft.

14. A method of damping vibrations of a hollow rotating shaft, which comprises
providing a plurality of damping fingers extending longitudinally in the shaft;
urging the fingers against inner surface portions of the shaft in response to centrifugal force; and
sliding the fingers relative to the inner surface portions of the shaft in response to shaft vibrations.

15. A method of damping vibrations of a hollow rotating shaft, which comprises:
providing a damping structure in the shaft;
urging portions of the damping structure outwardly against inner surface portions of the shaft in response to centrifugal force;
sliding the portions of the damping structure relative to the inner surface portions of the shaft in response to vibration of the shaft; and
absorbing vibrational energy by friction between the portions of the damping structure and the inner surface portions of the shaft.
